(19) United States
(12) Patent Application Publication
(10) Pub. No.: US 2013/0124415 A1
(43) Pub. Date: May 16, 2013

(54) SYSTEMS AND METHODS FOR SECURE AUTHENTICATION USING A WATERMARK

(71) Applicant: EBAY INC., San Jose, CA (US)

(72) Inventor: Upendra S. Mardikar, San Jose, CA (US)

(73) Assignee: EBAY INC., San Jose, CA (US)

(21) Appl. No.: 13/673,682

(22) Filed: Nov. 9, 2012

Related U.S. Application Data
(60) Provisional application No. 61/558,880, filed on Nov. 11, 2011.

(51) Int. Cl. G06Q 99/00; G06Q 20/40

(52) U.S. Cl. 705/44; 705/325

(57) ABSTRACT

Systems, methods, and devices for authenticating a user using a watermark are provided. A device for authenticating a user includes one or more processors configured to prepare information including a watermark and a request for user credentials in response to a request for service requiring authentication, wherein the watermark comprises at least one of an image, text, a sound, a photo, and a combination thereof that is chosen by the user, and match received user credentials to stored user credential information. The device also includes a network interface component coupled to a network, the network interface component configured to receive the request for the service requiring authentication, and transmit the information including the watermark and the request for user credentials. The device further includes a memory, the memory storing the user credential information for matching to received user credentials.

### RELATED APPLICATIONS

This application claims priority to U.S. Provisional Application No. 61/558,880, filed Nov. 11, 2011, the entire contents of which are hereby incorporated by reference in their entirety.

### BACKGROUND

### Technical Field

Embodiments disclosed herein are related to systems and methods for authenticating a user by requesting that a user review and validate a watermark provided by the authenticating server before supplying user credentials. In particular, systems and methods disclosed herein may enable a user purchasing items from a merchant server to securely pay for the purchased items using a payment provider by reviewing and validating a watermark provided by a payment processing server.

### RELATED ART

In order to enable convenient purchases of goods and services by consumers, the financial service industry has developed many alternative payment methods that allow a consumer to engage in a transaction and receive goods and services on credit. For example, such alternative payment methods may include checks, automatic teller machine (ATM) or debit cards, credit cards, charge cards. Prior to the birth of virtual commerce, such payment options provided adequate convenience and transactional security to consumers and merchants in the marketplace. Virtual commerce and the growth of the Internet as a medium for commerce have placed pressure on the payment options discussed above on the convenience, transactional security and profitability by the credit issuer. Currently, available payment options include significant shortcomings when applied to remote purchasers, such as purchases where the buyer and the seller (that is, the merchant) are not physically proximate during the transaction. Specific examples of remote purchases are mail order, telephone order, the Internet and wireless purchases.

As global commerce increases, security in transactions is more and more difficult to obtain. Many transactions are consummated by fraudsters, identification thieves and others that have somehow obtained the appropriate identification information regarding a consumer. For example, credit cards may be convenient to the consumer, but are subject to fraudulent use via theft of the account number, expiration date and address of the consumer. This, in turn, places the credit issuer at risk of offering credit to an consumer who is not credit-worthy, being the subject of consumer fraud or providing authorization to a merchant to provide services or ship goods to a fraudulent source.

Current available payment options include significant shortcomings when applied to remote purchasers, such as purchases where the buyer and the seller (that is, the merchant) are not physically proximate during the transaction. Further, regardless of the proximity of the consumer and the merchant, merchants and credit issuers alike continue to battle the problem of fraudulent purchases. Each new payment option and every new sales channel (in-store, telephone, mail and Internet) have, in turn, spawned innovation on the part of consumers willing to perpetrate fraud in order to obtain goods and services without paying for them.

In recent years, the birth of the Internet commerce industry and the continued growth in mail order and telephone order commerce have pushed the credit card to the forefront of these battles. Typically, merchants are forced to rely on credit cards because it is currently their only option in the remote purchase environment. However, regardless of the type of credit offered, low transactional security is offered to both merchants and consumers. This leads to significant cost for the consumers and the merchants, such as the consumer cost including the impairment of their credit record, the inconvenience of changing all of their credit card accounts and the financial cost in resolving the situation. Merchant costs may include the mitigation of fraud losses, including the cost in incremental labor, hardware and software to implement additional security checks in their sales/order entry software, higher transaction processing expense in the form of discount rates for credit cards and NSF fees for checks and higher fraud charge-offs for undetected fraudulent purchases.

With the continuing speed and ability of a consumer to gain credit, whether at a point-of-sale or through the use of an existing account, identity theft and fraud are on the increase. However, as is easily evident in today's marketplace, merchants are often more interested in providing a consumer with quick and efficient service with little hassle regarding the consumer's identity. Still further, such fraudsters are capable of stealing or otherwise illicitly obtaining certain static proprietary symbols (e.g., a corporate logo, a service logo, a specific message format, etc.) for use in “phishing” for the victim's data. For example, if the fraudster obtains a financial institution's logo and message format, he or she will send a message to the potential victim to enter their account or other valuable information. The victim, used to seeing the logo and message format, may, in many cases, provide this data to the fraudster, and lose considerable money as a result.

Prior art systems and methods have been developed in an attempt to stop or curtail this type of “phishing” activity. For example, some prior art systems have been developed which use non-machine readable blur code words or numbers that must be input by a human. However, this may only be effective for automated “phishing” techniques. Other attempts to stop this activity include requiring photographs on credit cards, and using ink-based security paper on checks. However, these methods have not been effective in many areas, including the prevention of online “phishing” expeditions. Accordingly, there is considerable room in the art for additional security techniques to prevent the activities of these fraudsters.

Accordingly, there is a need for devices, systems, and methods for providing authentication to online entities such as payment service providers that is secure and provides assurance to the users of the online entities that the authentication is secure.

### BRIEF DESCRIPTION OF THE FIGURES

FIG. 1 is a block diagram of a networked system, consistent with some embodiments.

FIG. 2 is a diagram illustrating a computing system, consistent with some embodiments.

FIGS. 3A and 3B is are illustrations of a user interface displaying a watermark to ensure secure online transactions, consistent with some embodiments.

FIG. 4 is a flowchart illustrating a method for authenticating a user, consistent with some embodiments.

FIG. 5 is a flowchart illustrating a method for authenticating a user, consistent with some embodiments.

FIG. 6 is a flowchart illustrating a method for authenticating a user for making a payment, consistent with some embodiments.

In the drawings, elements having the same designation have the same or similar functions.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

Consistent with some embodiments, there is provided a device for authenticating a user. The device includes one or more processors configured to prepare information including a watermark and a request for user credentials in response to a request for service requiring authentication, wherein the watermark comprises at least one of an image, text, a sound, a photo, and a combination thereof, that is chosen by the user and match received user credentials to stored user credential information. The device also includes a network interface component coupled to a network, the network interface component configured to receive the request for the service requiring authentication, and transmit the information including the watermark and the request for user credentials. The device further includes a memory, the memory storing the user credential information for matching to received user credentials.

Consistent with some embodiments, there is also provided a non-transitory computer-readable medium having instructions for execution by one or more processors that, when executed, cause the one or more processors to perform a method for authenticating a user. The method includes receiving a request for a service that requires authentication, transmitting information including a watermark and a request for user credentials, wherein the watermark comprises at least one of an image, text, a sound, a photo, and a combination thereof that is chosen by the user. The method also includes determining if received user credentials match stored user credential information, if user credentials are received, and authenticating the user and allowing the request for service if the received user credentials match the stored user credential information.

Consistent with some embodiments, there is further provided a non-transitory computer-readable medium having instructions for execution by one or more processors that, when executed, cause the one or more processors to perform a method for authenticating a user. The method includes transmitting a request for service, receiving information including a request for user credentials and a watermark that has been chosen by the user, displaying the received watermark to the user, and transmitting received user credential information if user enters the credential information in response to the watermark being an expected watermark, wherein the user does not enter the credential information if the watermark is not an expected watermark.

These and other embodiments will be described in further detail below with respect to the following figures.

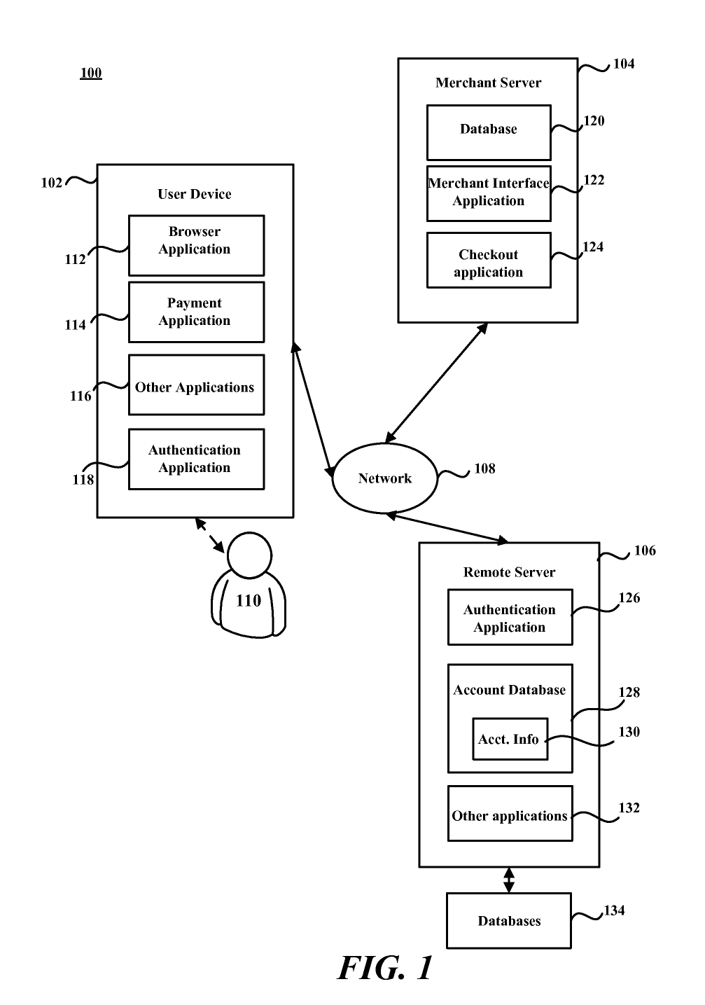

FIG. 1 is a block diagram of a networked system 100, consistent with some embodiments. System 100 includes a user device 102, a merchant server 104, and a remote server 106 in communication over a network 108. User 110 may be communicating with merchant server 104 and/or remote server 106 over network 108 using user device 102. Remote server 106 may be a payment service provider server that may be maintained by a payment provider, such as PayPal, Inc. of San Jose, Calif. Remote server 106 may be maintained by other service providers in different embodiments. Remote server 106 may also be maintained by an entity with which sensitive credentials and information may be exchanged with user device 102 and/or merchant server 104. Remote server 106 may be more generally a web site, an online content manager, a service provider, such as a bank, or other entity who provides content to a user requiring user authentication or login.

Network 108, in one embodiment, may be implemented as a single network or a combination of multiple networks. For example, in various embodiments, network 108 may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

User device 102 may be a mobile device such as a smartphone such as an iPhone™ or other mobile device running the iOS™ operating system, the Android™ operating system, a BlackBerry™ operating system, the Microsoft® Windows® Phone operating system, Symbian™ OS, or webOS™. User device 102 may also be a tablet computer, such as an iPad™ or other tablet computer running one of the aforementioned operating systems. It should be appreciated that, in various embodiments, user device 102 may be referred to as a user device or a customer/client device without departing from the scope of the present disclosure. User device 102 may also be a PC or laptop or netbook, a set-top box (STB) such as provided by cable or satellite content providers, or a video game system console such as the Nintendo® Wii™, the Microsoft® Xbox 360™, or the Sony® PlayStation™ 3, or other video game system consoles. User device 102, in one embodiment, may be implemented using any appropriate combination of hardware and/or software configured for wired and/or wireless communication over network 108. For example, user device 102 may be implemented as a wireless telephone (e.g., smart phone), tablet, personal digital assistant (PDA), notebook computer, and/or various other generally known types of wired and/or wireless mobile computing devices. Consistent with some embodiments, user device 102 may include any appropriate combination of hardware and/or software having one or more processors and capable of reading instructions stored on a non-transitory machine-readable medium for execution by the one or more processors. Consistent with some embodiments, user device 102 includes a machine-readable medium, such as a memory (not shown) that includes instructions for execution by one or more processors (not shown) for causing user device 102 to perform specific tasks. For example, such instructions may include authenticating user device 102 to remote server 106 to access services provided by remote server 106 and/or conducting financial transactions with remote server 106 for purchasing items offered by merchant server 104. Further, content may be content displayed by particular applications or “apps” stored in a memory of user device 102 and executed by one or more processors executing in user device 102. One example of an application is a browser application 112 that displays content, such as a web page or a user interface using a browser, a payment application 114 that is used to make payments in conjunction with remote server 106 for items purchased from, for example, merchant server 104, and other applications 116. Some common forms of machine-readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which one or more processors or computer is adapted to read.

Other applications 116 as may be desired in one or more embodiments to provide additional features available to user 110, including accessing a user account with remote server 106. For example, other applications 116 may include interfaces and communication protocols that allow the user to receive and transmit information through network 108 and to remote server 106 and other online sites. Other applications 116 may also include security applications for implementing client-side security features, programmatic client applications for interfacing with appropriate application programming interfaces (APIs) over network 108 or various other types of generally known programs and/or applications. Other applications 116 may include mobile apps downloaded and resident on user device 102 that enables user 110 to access content through the apps.

Consistent with some embodiments, user device 102 may also include an authentication application 118, which may be used to authenticate user 110 to remote server 106 over network 108. According to some embodiments, authentication application 118 may be used to authenticate user 110 to access services provided by remote server 106. Such services may be payment services such as authenticating a transaction for items purchased from merchant server 104 through remote server 106 over network 108. For example, browser application 110 may be implemented as a web browser to view information available over network 108. Browser application 110 may include a software program, such as a graphical user interface (GUI), executable by one or more processors that is configured to interface and communicate with the remote server 106, a merchant interface provided by merchant server 104, or other servers managed by content providers or merchants via network 108. For example, user 110 is able to access websites to find and purchase items from a merchant through a payment service provider, such as PayPal, as well as access user account information or web content.

Merchant server 104 may be maintained, for example, by a merchant or seller offering various products and/or services in exchange for payment to be received over network 108. Consistent with some embodiments, merchant server 104 may be maintained by anyone or any entity that receives money, which includes charities as well as retailers and restaurants. Merchant server 104 includes a database 120 identifying available products and/or services (e.g., collectively referred to as items) which may be made available for viewing and purchase by user 110. Accordingly, merchant server 104 also includes a merchant interface application 122 which may be configured to serve information over network 108 to browser application 110 of user device 102. In one embodiment, user 110 may interact with merchant interface application 122 through browser application 112 over network 108 in order to view various products, food items, or services identified in database 120. Merchant server 104 also includes a checkout application 124 which may be configured to facilitate the purchase by user 110 of goods or services identified by merchant interface application 122. Checkout application 124 may be configured to accept payment information from or on behalf of user 110 through payment service provider server 106 over network 108. For example, checkout application 124 may receive and process a payment confirmation from payment service provider server 106, as well as transmit transaction information to the payment provider and receive information from the payment provider. Checkout application 124 may also be configured to accept one or more different funding sources for payment.

Remote server 106, according to some embodiments, may be maintained by an online payment provider, which may provide processing for online financial and information transactions on behalf of user 110. Remote server 106 may include at least authentication application 126, which may be adapted to interact with user device 102 and/or merchant server 104 over network 108 to authenticate user 110 and/or a merchant using merchant server 104 to, for example, permit user 110 and/or a merchant to access services on remote server 106. Such services may include payment services. Remote server 106 also maintains a plurality of user accounts in account database 128, each of which may include account information 130 associated with individual users. For example, account information 130 may include private financial information of users of devices such as account numbers, credentials, passwords, device identifiers, user names, phone numbers, credit card information, bank information, or other financial information which may be used to facilitate online transactions by user 110. Consistent with some embodiments, user 110 or a merchant may be authenticated to remote server 106 through authentication application 130 based on information including credentials stored in account database 118 and/or account information. Remote server 106 may also include other applications 132. Such other applications 132 may include a payment processing application used to process payments made by user 110 for purchasing items offered by merchant server 104. Such a payment processing application may be configured to interact with merchant server 104 on behalf of user 110 during a transaction with checkout application 124 to track and manage purchases made by users and which funding sources are used. Other applications 132 may also include a transaction processing application, which may be part of a payment application or separate, may be configured to receive information from a user device 102 and/or merchant server 104 for processing and storage in one or more databases 134. The transaction processing application may include one or more applications to process information from 130 and/or the merchant server 104 for processing a payment from user 110 through a user device 102 while on a website or app as described herein. As such, the transaction processing application of other applications 132 may store details of an order and associate the details with a purchase identifier for individual users. A payment application may be further configured to determine the existence of and to manage accounts in account database 128 for user 110, as well as create new accounts if necessary, such as the set up, management, and use of purchase identifiers.

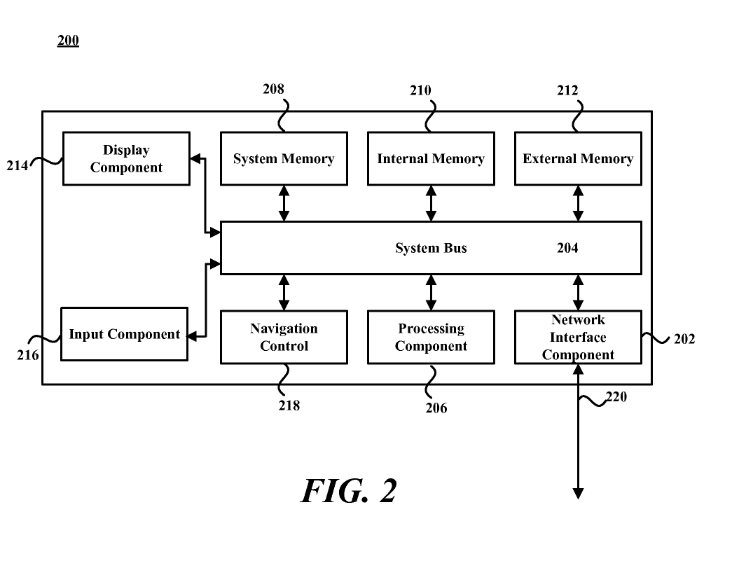

FIG. 2 is a diagram illustrating computing system 200, which may correspond to any of user device 102, merchant server 104, or remote server 106, consistent with some embodiments. Computing system 200 may be a mobile device such as a smartphone such as an iPhone™ or other mobile device running the iOS™ operating system, the Android™ operating system, a BlackBerry™ operating system, the Microsoft® Windows® Phone operating system, Symbian™ OS, or webOS™, a tablet computer such as the iPad™ or other similar device running the aforementioned operating systems. Computing system 200 may also be personal computer, laptop computer, netbook, or tablet computer. Further, computing system 200 may also be a server or one server amongst a plurality of servers. As shown in FIG. 2, computing system 200 includes a network interface component (NIC) 202 configured for communication with a network such as network 108 shown in FIG. 1. Consistent with some embodiments, NIC 202 includes a wireless communication component, such as a wireless broadband component, a wireless satellite component, or various other types of wireless communication components including radio frequency (RF), microwave frequency (MWF), and/or infrared (IR) components configured for communication with network 108. Consistent with other embodiments, NIC 202 may be configured to interface with a coaxial cable, a fiber optic cable, a digital subscriber line (DSL) modem, a public switched telephone network (PSTN) modem, an Ethernet device, and/or various other types of wired and/or wireless network communication devices adapted for communication with network 108.

Consistent with some embodiments, computing system 200 includes a system bus 204 for interconnecting various components within computing system 200 and communication information between the various components. Such components include a processing component 206, which may be one or more processors, micro-controllers, or digital signal processors (DSP), a system memory component 208, which may correspond to random access memory (RAM), an internal memory component 210, which may correspond to read-only memory (ROM), and a external or static memory 212, which may correspond to optical, magnetic, or solid-state memories. Consistent with some embodiments, computing system 200 further includes a display component 214 for displaying information to a user 110 of computing system 200. Display component 214 may be a liquid crystal display (LCD) screen, an organic light emitting diode (OLED) screen (including active matrix AMOLED screens), an LED screen, a plasma display, or a cathode ray tube (CRT) display. Computing system 200 may also include an input component 216, allowing for a user 110 of computing system 200 to input information to computing system 200. Such information could include payment information such as an amount required to complete a transaction, account information, authentication information, or identification information. An input component 216 may include, for example, a keyboard or key pad, whether physical or virtual. Computing system 200 may further include a navigation control component 218, configured to allow a user to navigate along display component 214. Consistent with some embodiments, navigation control component 218 may be a mouse, a trackball, or other such device. Moreover, if device 200 includes a touch screen, display component 214, input component 216, and navigation control 218 may be a single integrated component, such as a capacitive sensor-based touch screen.

Computing system 200 may perform specific operations by processing component 206 executing one or more sequences of instructions contained in system memory component 208, internal memory component 210, and/or external or static memory 212. In other embodiments, hard-wired circuitry may be used in place of or in combination with software instructions to implement the present disclosure. Logic may be encoded in a computer readable medium, which may refer to any medium that participates in providing instructions to processing component 206 for execution. Such a medium may take many forms, including but not limited to, non-volatile media, volatile media, and transmission media. The medium may correspond to any of system memory 208, internal memory 210 and/or external or static memory 212. Consistent with some embodiments, the computer readable medium is non-transitory. In various implementations, non-volatile media include optical or magnetic disks, volatile media includes dynamic memory, and transmission media includes coaxial cables, copper wire, and fiber optics, including wires that comprise system bus 204. According to some embodiments, transmission media may take the form of acoustic or light waves, such as those generated during radio wave and infrared data communications. Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computing system 200. In various other embodiments of the present disclosure, a plurality of computing systems 200 coupled by a communication link 220 to network 108 (e.g., such as a LAN, WLAN, PTSN, and/or various other wired or wireless networks, including telecommunications, mobile, and cellular phone networks) may perform instruction sequences to practice the present disclosure in coordination with one another. Computing system 200 may transmit and receive messages, data and one or more data packets, information and instructions, including one or more programs (i.e., application code) through communication link 220 and network interface component 202. Communication link 220 may be wireless through a wireless data protocol such as Wi-Fi™, 3G, 4G, HDSPA, LTE, RF, NFC, or through a wired connection. Network interface component 202 may include an antenna, either separate or integrated, to enable transmission and reception via communication link 220. Received program code may be executed by processing component 206 as received and/or stored in memory 208, 210, or 212.

Consistent with some embodiments, user 110 using computing system 200 that may correspond to user device 102 may wish to interact with or remote server 106 or purchase items from merchant server 104 using payment services of remote server 106. In order to access services offered by remote server 106, user 110 may be required to authenticate to remote server 106. Such authentication may require the user to, at the request of a prompt from remote server 106, enter certain credentials such as a user name and password that must match credentials stored in account information 130. However, in some instances attackers may spoof the authentication process of remote server 106 to attempt to trick user 110 into entering their credentials which will then be captured by the attacker. In order to assure user 110 that their credentials are being entered on a trustworthy site, or at least the site that the user is expecting to provide credentials to, authentication application 126 may produce a watermark that will be displayed to user 110 on display component 214 of user device 102. The watermark may be a image, sound, text, or other media that is known to user and expected by user to demonstrate that the site is trustworthy.

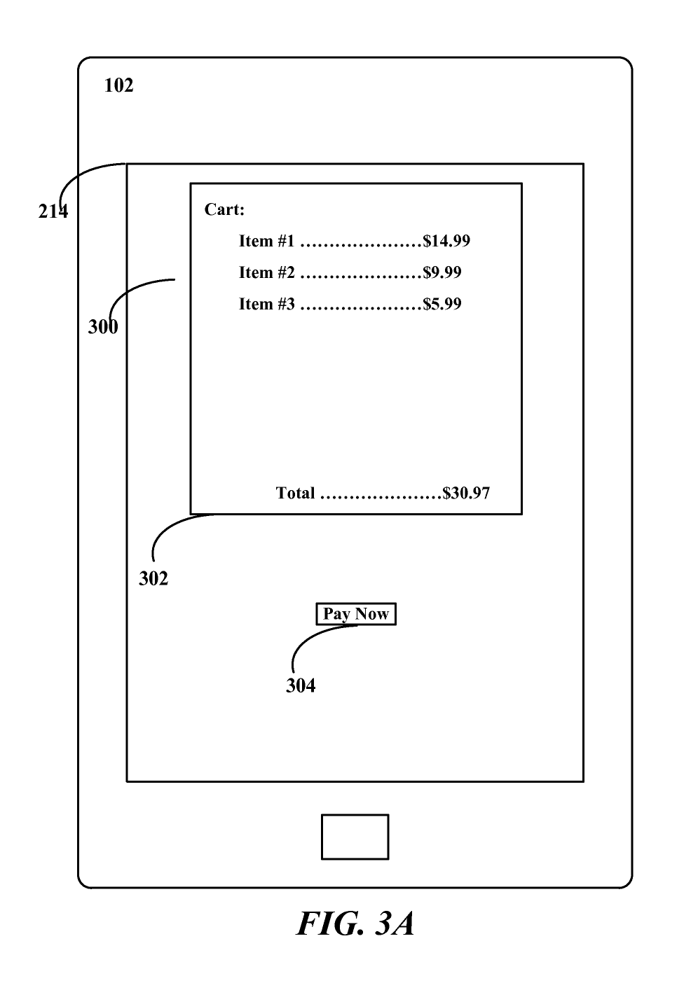

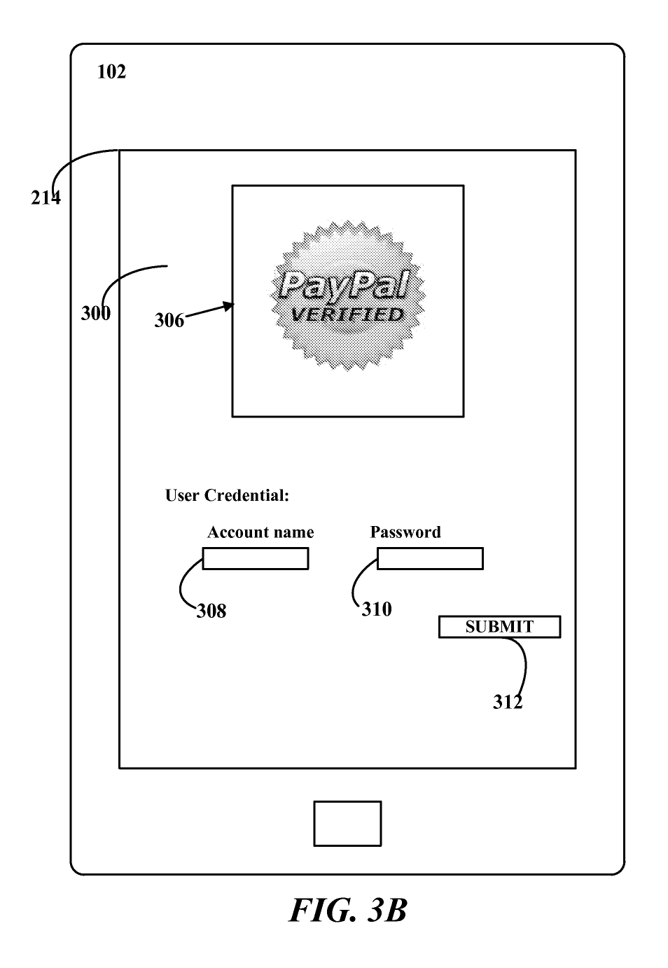

FIGS. 3A and 3B are illustrations of a user interface displaying a watermark to ensure secure online transactions, consistent with some embodiments. As shown in FIG. 3A display component 214 of user device 102 may display a user interface 300. User interface 300 may display a cart 302 of items that user 110 has selected for purchase from merchant server 104. In order to purchase the items listed in cart 302, user may select the Pay Now button 304 to begin a payment process. Consistent with some embodiments, selecting Pay Now button 304 may begin a payment process between user 102, merchant server 104 and remote server 106. For example, selection of Pay Now button 304 may initiate checkout application 124 to accept payment information from or on behalf of user 110 through remote server 106 over network 108 wherein checkout application 124 may transmit transaction information to the payment provider such as remote server 106 and receive information from the payment provider. Consistent with some embodiments, a cookie having certain information about user 110 may be sent directly to remote server prior to receiving information from the payment provider. The information received from remote server 106 may include information from authentication application 126, wherein user 110 will be required to authenticate with remote server 106, possibly through checkout application 124 of merchant server 104, to complete the transaction. User 110 may be required to enter credentials in order to authenticate to remote server 104, and may be presented with a prompt to enter their credentials such as a login screen. As discussed above, attackers may spoof login screens, making them look like an actual login screen provided by remote server 106 in the hopes of tricking user 110 to enter their credentials. In order to reassure user 110 that a login screen or other credential providing the prompt is legitimate and is provided by remote server 106, remote server may embed, append, or otherwise display a watermark to user 110 as an indication that the login screen or other credential prompt is legitimate and provided by remote server 106. Consistent with some embodiments, the watermark displayed to user 110 is displayed in a pop-up or mini-browser without taking user 110 away from the current application that they are viewing and using.

As shown in FIG. 3B, display component 214 of user device 102 displays user interface 300 having a watermark 306 displayed thereon. Consistent with some embodiments, watermark 306 may be an image, text, a sound or series of sounds such as music, an animation, or photo. Watermark 306 may be assigned by remote server 106 so that each user 110 attempting to access remote server 106 will expect the same watermark 306. Alternatively, user 110 may select watermark 306 during an initial authentication process or registration process. When user 110 sees an expected watermark 306 after initiating a payment shown in FIG. 3A, user 110 will know that the authentication page is trustworthy and expected, and user 110 may enter their credentials, such as an account name 308 and password 310. Consistent with some embodiments, account name 308 may be a user name, e-mail address, or account number, and password 310 may be a password, a user-selection, a or a personal identification number (PIN), and a combination thereof. Once user 110 has entered the one or more credentials, user may select the SUBMIT button 312, where user credentials 308 and 310 will be transmitted over network 108 to remote server where they are compared to credential information stored in account information 130 of account database 128. If remote server 106 determines that the transmitted credentials 308 and 310 match credentials stored in account information of account database 128, remote server 106 will authenticate user 110, allowing user to access services provided by remote server 106, such as completing a purchase of items from merchant server 104. If user 110 does not see watermark 306, or the expected or correct watermark 306 is not displayed, user 110 may rightfully be wary of providing credentials 308 and 310, and can cancel the authentication by terminating the application running on user device 102 or selecting cancel, or hitting a “back” button, for example. Further, if the expected or correct watermark 306 is not displayed, user 110 may attempt to authenticate to remote server 106 using additional authentication processes, such as in-band or out-of-band authentication.

Although FIGS. 3A and 3B illustrate authenticating to remote server 106 in the context of completing a payment, the authentication shown in these figures maybe applicable to any authentication to remote server 106. For example, if user 110 wishes to access account information 130 stored in account database 128, user may be required to authenticate to remote server 106 in order to access this information. During authentication, user 110 may be presented with a watermark 306 and user 110 must decide whether watermark 306 is the correct or expected watermark 306 before electing to enter credentials 308 and 310 and submit credentials 308 and 310 to remote server 106.

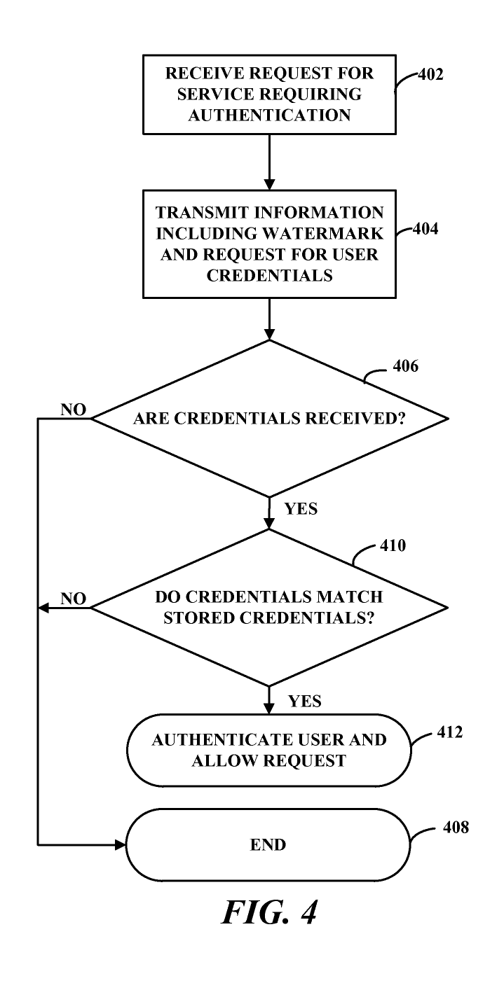

FIG. 4 is a flowchart illustrating a method for authenticating a user, consistent with some embodiments. For the purpose of illustration, FIG. 4 will be described with reference to FIGS. 1-2, 3A, and 3B. The method shown in FIG. 4 may be embodied in computer-readable instructions for execution by one or more processors in processing component 206 such that the steps of the method may be performed by remote server 106. As shown in FIG. 4, remote server 106 may receive a request for a service requiring authentication (402). The request may be transmitted by user 110 using user device 102 over network 108. Alternatively, the request may be transmitted by merchant server 104 over network by checkout application 124 as part of a payment for items user 110 wishes to purchase from merchant server 104. Remote server 106 may then transmit information over network to user device 102, merchant server 104, or a combination thereof, which includes a request for credentials 308 and 310 and watermark 306 (404). Remote server 406 may then determine if credentials are received (406). Consistent with some embodiments, user 110 may inspect the transmitted watermark 306 to determine if it is correct and/or expected and, if it is correct, enter credentials 308 and 310 and submit 312 credentials 308 and 310 to remote server 306. If remote server 106 does not receive credentials 308 or 310 from user 110, remote server 106 may assume that watermark was not expected and/or correct, which resulted in user abandoning the authentication effectively ending the method (408). If remote server 106 receives credentials 308 and 310 from user 110 who inspected watermark 306 and determined that it was expected and/or correct, remote server 106 may determine if the received credentials 308 and 310 from user 110 and user device 102 match credentials stored account information 130 in account database 128 (410). If the received credentials do not match the stored credentials, remote server 106 may deny the request for service, effectively ending the authentication (408). If remote server 106 determines that the credentials match the stored credentials, remote server 106 may authenticate user 110 and allow the request for service (412). As a result of allowing the service, user 110 may be able to, for example, authorize a payment to merchant server 104 for the purchase of items.

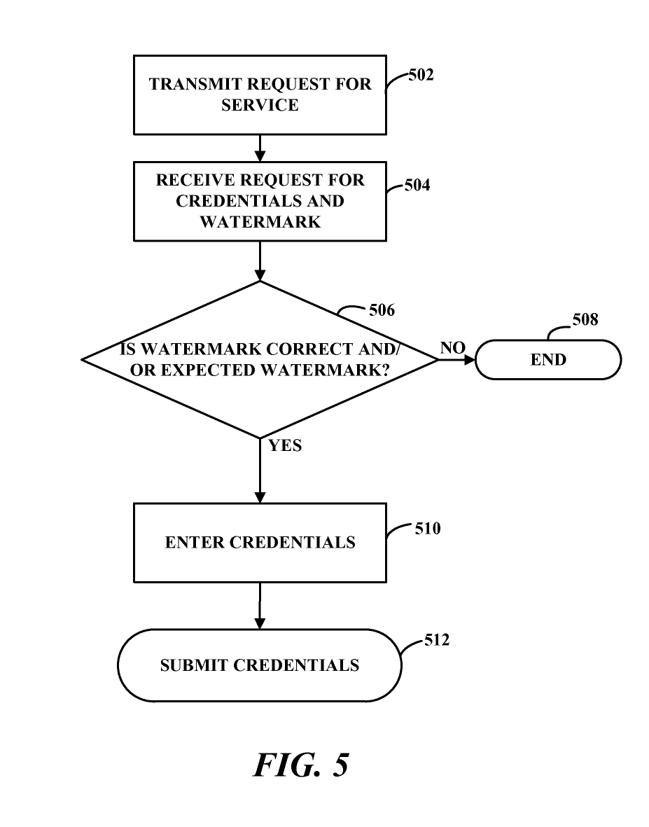

FIG. 5 is a flowchart illustrating a method for authenticating a user, consistent with some embodiments. For the purpose of illustration, FIG. 5 will be described with reference to FIGS. 1-2, 3A, and 3B. The method shown in FIG. 5 may be embodied in computer-readable instructions for execution by one or more processors in processing component 206 such that the steps of the method may be performed by user device 102 and/or merchant server 104. As shown in FIG. 5, user 110, using user device 102, may transmit a request for service to remote server 106 over network 108 (502). According to some embodiments, the request may be for authorizing a payment to merchant server 104 for the purchase of items, such as items in cart 302. Moreover, the request may be transmitted to remote server 106 by checkout application 124 of merchant server 104 for user 110 as part of a purchase transaction being conducted between user 110 and merchant server 104. User device 102 may then receive a request for credentials 308 and 310 and a watermark 306 which are displayed to user 110 by display component 214 of user device 102 (504). As discussed above, watermark 306 may be an image, text, a sound or series of sounds such as music, an animation, or photo. Watermark 306 may be assigned by remote server 106 so that each user 110 attempting to access remote server 106 will expect the same watermark 306. Alternatively, user 110 may select watermark 306 during an initial authentication process. Credentials 308 and 310 may be an account name, a user name, e-mail address, account number, password, PIN, user selection, or a combination thereof. User 110 may then analyze watermark 306 displayed to user 110 on display component 214 of user device 102 to determine if watermark 306 is correct and/or expected (506). If watermark 306 is not correct and/or expected, user will abandon or otherwise cancel the authentication, effectively ending the authentication (508). If watermark 306 displayed by display component 214 of user device 102 is a correct and/or expected watermark, user 110 will proceed to enter credentials 308 and 310 (510). User 110 may then submit 314 credentials 308 and 310 to remote server 106 for authentication. If remote server 106 determines that the credentials match the stored credentials, remote server 106 may authenticate user 110 and allow the request for service. As a result of allowing the service, user 110 may be able to, for example, authorize a payment to merchant server 104 for the purchase of items.

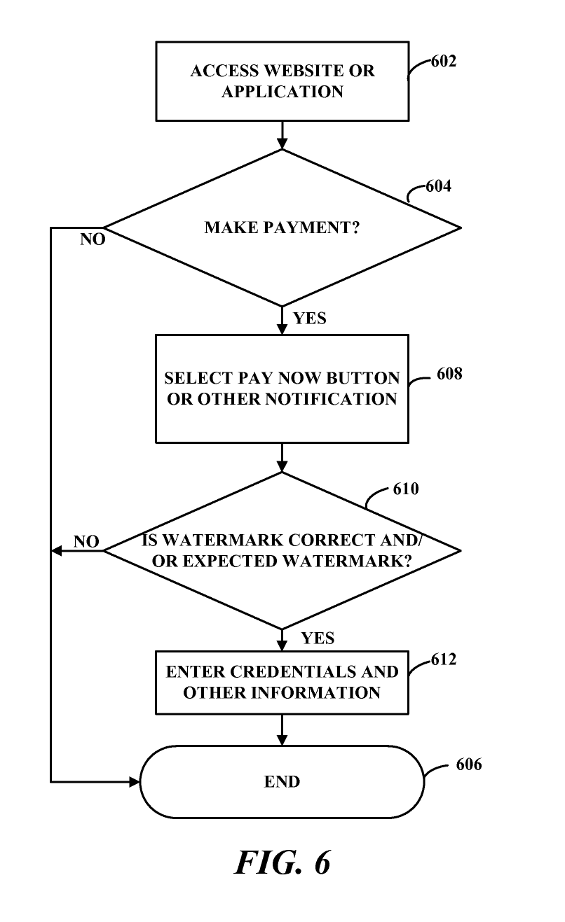

FIG. 6 is a flowchart illustrating a method for authenticating a user for making a payment, consistent with some embodiments. For the purpose of illustration, FIG. 6 will be described with reference to FIGS. 1-2, 3A, and 3B. The method shown in FIG. 6 may be embodied in computer-readable instructions for execution by one or more processors in processing component 206 such that the steps of the method may be performed by any of user device 102, merchant server 104, remote server 106, and a combination thereof. As shown in FIG. 6, user 110 may access a website, online site, or other content provider site or application (602). The site or application may be a game, a news provider, or a shopping site. Consistent with some embodiments, the website or application accessed by user 110 may be hosted on merchant device 104 and/or remote server 106, and may be accessed by user 110 using user device 102 over network 108. Once user 110 has accessed the site or application. user 110 may decide whether to make a payment (604). Consistent with some embodiments, user 110 may decide to make a payment if user 110 is accessing a news or content site and purchasing a full view of an article or additional information on the site. Moreover, user 110 may be accessing a gaming site and be attempting to purchase additional access to a game or in-game items. User may be presented with offers to purchase items during a session by the site, such as through pop-ups or overlays displayed by display component 214 of user device 102, without leaving the current session. User may also be presented with static or dynamic buttons, such as Pay Now button 304, on the site that allow user 110 to select a desired button to make a specific purchase. In some embodiments, user 110 may have selected items for purchase from merchant server 104 and checkout application 124 of merchant server 104 may present a user interface 300 that displays a cart 302 of the selected items along with a Pay Now button 304.

If user 110 does not decide to make a payment, the method ends (606). If user 110 decides to make a payment, user 110 may select Pay Now button 304, or other button or notification that, when selected, provides an indication of user 110's decision to make a payment (608). Consistent with some embodiments, user 110 may use input component 216 and/or navigation control 218 to hovers a pointer over Pay Now button 304 or other similar button or notification. When user 110 manifests their decision to make a payment by selecting Pay Now button 304 or other button or notification the selection will cause a watermark 306 to be displayed by display component 214 of user device 102. Watermark 306 may be shown on a pop-up screen or an overlay on the current site or application. As discussed above, watermark 306 may be an image, text, a sound or series of sounds such as music, an animation, or photo. Watermark 306 may be assigned by remote server 106 so that each user 110 attempting to access remote server 106 will expect the same watermark 306. Alternatively, user 110 may select watermark 306 during an initial authentication process. User 110 may then inspect watermark 306 to determine if watermark 306 is correct and/or expected (610). If user 110 determines that watermark 306 is not correct and/or expected, user 110 will not believe that the site or application is trustworthy and abandon the authentication process (606). If user 110 determines that watermark 306 is correct and/or expected, user 110 may be assured that the entity requesting information is the provider. User 110 then may enter credentials 308 and 310 or other information required for authentication (612). Credentials 308 and 310 may be an account name, a user name, e-mail address, account number, password, PIN, user selection, or a combination thereof, and may be requested from user 110 using form fields on a user interface such as user interface 300. Consistent with some embodiments, the fields may be presented on a new screen or pop-up of on the same screen as watermark 300. Once entered, credentials and other information may be submitted 312 to remote server 106. The other information may include the amount of the payment request, merchant identifiers, user device identifiers, and any other requested user information. This information may then be processed by remote server 106 to determine whether the payment can be approved using, for example, account information 130 in account database 128. After processing, user 110 may be notified whether the payment was approved. User interface 300 displaying watermark 306 may then disappear from display component 214 of user device 102.

Software, in accordance with the present disclosure, such as program code and/or data, may be stored on one or more machine-readable mediums, including non-transitory machine-readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Consequently, embodiments as described herein may provide methods, systems, and devices that provide assurance to users that authentication to an online entity such as a payment service provider is secure by providing a watermark for the user to review. By reviewing the watermark, the user will be able to determine if the site the user is attempting to authenticate to is authentic or possibly an attacker. The examples provided above are exemplary only and are not intended to be limiting. One skilled in the art may readily devise other systems consistent with the disclosed embodiments which are intended to be within the scope of this disclosure. As such, the application is limited only by the following claims.

What is claimed is:

1. A device for authenticating a user, comprising:
one or more processors configured to:
prepare information including a watermark and a request for user credentials in response to a request for service requiring authentication, wherein the watermark comprises at least one of an image, text, a sound, a photo, and a combination thereof that is chosen by the user; and
match received user credentials to stored user credential information;
a network interface component coupled to a network, the network interface component configured to:
receive the request for the service requiring authentication; and
transmit the information including the watermark and the request for user credentials; and
a memory, the memory storing the user credential information for matching to received user credentials.

2. The device of claim 1, wherein the user credentials comprise at least one of a user name, an account name, a password, a personal identification number (PIN), and a combination thereof.

3. The device of claim 1, wherein if the received user credentials match the stored user credential information the user is authenticated by the device and allowed access to the requested service.

4. The device of claim 1, wherein the request for the service requiring authentication is received from a merchant server.

5. The device of claim 4, wherein the request is sent from the merchant server for processing a payment for goods purchased from the merchant server by the user.

6. The device of claim 1, wherein the transmitted watermark is presented to the user on a user device without taking the user away from a current application being executed by the user device.

7. A non-transitory computer-readable medium having instructions for execution by one or more processors that, when executed, cause the one or more processors to perform a method for authenticating a user, the method comprising:
receiving a request for a service that requires authentication;
transmitting information including a watermark and a request for user credentials, wherein the watermark comprises at least one of an image, text, a sound, a photo, and a combination thereof that is chosen by the user;
determining if received user credentials match stored user credential information, if user credentials are received; and
authenticating the user and allowing the request for service if the received user credentials match the stored user credential information.

8. The method of claim 7, wherein the user credentials comprise at least one of a user name, an account name, a password, a personal identification number (PIN), and a combination thereof.

9. The method of claim 7, wherein if the received user credentials match the stored user credential information the user is authenticated by the device and allowed access to the requested service.

10. The method of claim 7, receiving a request for service requiring authentication comprises receiving the request for service from a merchant server.

11. The method of claim 10, wherein receiving the request from the merchant server comprises receiving the request for processing a payment for goods purchased from the merchant server by the user.

12. The method of claim 7, wherein transmitting information including a watermark comprises transmitting the watermark to a user device and displaying the watermark to the user on the user device without taking the user away from a current application being executed by the user device.

13. A non-transitory computer-readable medium having instructions for execution by one or more processors that, when executed, cause the one or more processors to perform a method for authenticating a user, the method comprising:
transmitting a request for service;
receiving information including a request for user credentials and a watermark, the watermark having been chosen by the user;
displaying the received watermark to the user; and
transmitting received user credential information if user enters the credential information in response to the watermark being an expected watermark, wherein the user does not enter the credential information if the watermark is not an expected watermark.

14. The method of claim 13, wherein displaying the received watermark comprises displaying at least one of an image, text, a photo, and a combination thereof.

15. The method of claim 13, wherein displaying the received watermark comprises playing a sound.

16. The method of claim 13, wherein transmitting received user credential information comprises transmitting at least one of a user name, an account name, a password, a personal identification number (PIN), and a combination thereof.

17. The method of claim 13, wherein transmitting a request for service comprises transmitting a request to process a payment with a payment process server.

18. The method of claim 17, wherein the payment comprises a payment for items being purchased from a merchant server.

19. The method of claim 13, wherein displaying the watermark comprises displaying the watermark as an overlay to currently displayed content.

20. The method of claim 13, wherein displaying the watermark comprises displaying the watermark as a pop-up separate from currently displayed content, without taking the user away from the currently displayed content.
